(19) United States
(12) Patent Application Publication
(10) Pub. No.: US 2025/0389624 A1
(43) Pub. Date: Dec. 25, 2025

(54) GAP MEASUREMENT AND FAULT PREDICTION SYSTEM FOR VEHICLE SEATS

(71) Applicant: BRILS Co., Ltd., Incheon (KR)

(72) Inventor: Jin JEON, Incheon (KR)

(73) Assignee: BRILS Co., Ltd., Incheon (KR)

(21) Appl. No.: 19/241,821

(22) Filed: Jun. 18, 2025

(30) Foreign Application Priority Data
Jun. 19, 2024 (KR) 10-2024-0079853

(51) Int. Cl. G01M 99/00; B08B 5/02; B25J 5/00; B60N 2/70; B62D 65/00; B62D 65/02; B62D 65/14

(52) U.S. Cl. CPC G01M 99/005; B08B 5/023; B25J 5/005; B60N 2/7017; B62D 65/005; B62D 65/022; B62D 65/14

(57) ABSTRACT

The present disclosure relates to a vehicle seat gap measurement and fault prediction system that measures the gap between two closely arranged seats in a vehicle seat assembly and predicts the likelihood of seat fault based on sensing information generated during gap measurement or through artificial intelligence analysis. The system includes at least: an inspection unit that retreats along a rail frame to approach a main frame when a vehicle seat moves, and advances along the rail frame to face a measurement position of the vehicle seat during gap measurement, and senses a gap between the first seat and the second seat; a conformity determination unit that determines whether the vehicle seat is non-defective by analyzing sensing information transmitted from an inspection unit; and a fault prediction unit that predicts a potential fault of the vehicle seat based on the sensing information or based on artificial intelligence analysis.

### CROSS-REFERENCE TO RELATED APPLICATIONS

This application claims the benefit of Korean Patent Application No. 10-2024-0079853, filed on Jun. 19, 2024, in the Korean Intellectual Property Office, the disclosure of which is incorporated herein in its entirety by reference.

### TECHNICAL FIELD

The present invention relates to a system for measuring a gap in a vehicle seat and predicting a fault, and more particularly, to a vehicle seat gap measurement and fault prediction system that is configured to measure a gap between two seats assembled in close contact during vehicle seat manufacturing, and to predict the likelihood of a fault in the vehicle seat based on sensing information generated during the gap measurement or through analysis using artificial intelligence.

### BACKGROUND

In general, vehicle seats are subjected to repeated loads due to the occupant's repeated seating over a long period and vibrations caused by driving on uneven road surfaces. As a result, the surface material may wear out, become stretched, develop wrinkles, or lift, thereby degrading the appearance quality. In addition, the shock-absorbing member, such as polyurethane foam, which is housed inside the surface material, may be compressed downward due to the same causes and fail to function properly.

In addition, in the case of a vehicle seat in which two seat parts are assembled in close contact, a gap between the two seats may fall outside the normal range due to manufacturing defects or the like, which could lead to a decline in manufacturing quality.

Meanwhile, the aforementioned background art is technical information that the inventor possessed for the derivation of the present invention or acquired in the course of its development, and therefore, it cannot necessarily be regarded as prior art that was publicly known before the filing of the present invention.

### SUMMARY

In one embodiment according to the present invention, a vehicle seat gap measurement and fault prediction system includes a main frame installed at one side of a vehicle production line for moving a seat tray on which a vehicle seat, in which a first seat and a second seat are assembled in close contact, is mounted; a rail frame installed in a horizontal direction at an upper portion of the main frame while facing the vehicle production line; an inspection unit coupled to the rail frame so as to be slidable along the rail frame, the inspection unit being configured to retract along the rail frame to allow access to the main frame during movement of the vehicle seat, and to advance along the rail frame to face a measurement position of the vehicle seat during gap measurement, and to sense a gap between the first seat and the second seat; a normality determination unit configured to determine whether the vehicle seat is acceptable based on sensing information transmitted from the inspection unit; and a fault prediction unit configured to predict the possibility of a fault in the vehicle seat based on the sensing information transmitted from the inspection unit or through analysis using artificial intelligence.

In one embodiment, the inspection unit may be configured to sense a gap between the first seat and the second seat while tracking a folding or unfolding process of each of the first seat and the second seat.

In one embodiment, the inspection unit may be configured to sense a gap between the first seat and the second seat by analyzing a difference in speed or a difference in displacement during a folding or unfolding process of each of the first seat and the second seat.

In one embodiment, the inspection unit may be configured to analyze a folding or unfolding speed of the first seat and the second seat by analyzing the position of an individual seat, which is either the first seat or the second seat.

In one embodiment, the rail frame may include a horizontal frame installed in a manner facing the vehicle production line at an upper portion of the main frame so as to be perpendicular to a movement direction of the vehicle seat; a sliding hole formed to extend in a longitudinal direction along a middle portion of the horizontal frame so that an upper portion of the inspection unit is seated thereon and movable; a servomotor installed above a rear of the horizontal frame; and a ball screw coupled to a drive shaft of the servomotor by shaft coupling and arranged along an upper side of the sliding hole, wherein the upper portion of the inspection unit is coupled to the ball screw by bolt fastening, and the ball screw is rotated in a forward or reverse direction by the servomotor to move the inspection unit forward or backward along the sliding hole.

In one embodiment, the inspection unit may include a horizontal slider disposed in the sliding hole and coupled to the ball screw by bolt-nut engagement, the horizontal slider being configured to move along the sliding hole as the ball screw is rotationally driven in a forward or reverse direction; a vertical body installed on a lower side of the horizontal slider; a sensor casing disposed below the vertical body; a gap measurement sensor installed in the sensor casing and configured to sense a gap between the first seat and the second seat; and a bundle connector configured to interconnect the vertical body and the sensor casing.

In one embodiment, the gap measurement sensor may be configured to move together while tracking the first seat and the second seat when either the first seat or the second seat is folded or unfolded, and simultaneously sense a gap between the first seat and the second seat.

In one embodiment, the inspection unit may be configured to sense a gap between the first seat and the second seat at various angles during the folding or unfolding process, even when the overall folding or unfolding speed of either the first seat or the second seat is within a normal range.

In one embodiment, the fault prediction unit may be configured to determine that there is a possibility of a defect in a drive system or gear part of the vehicle seat when a partial gap difference or speed difference occurs during a folding or unfolding process of either the first seat or the second seat.

In one embodiment, the fault prediction unit may be configured to construct an artificial intelligence-based fault prediction model for a vehicle seat, which is trained to predict the possibility of a fault in the vehicle seat using, as input information, abnormal speed data by operation position and abnormal gap data by operation position during folding or unfolding of the vehicle seat, the data being transmitted from the inspection unit.

In one embodiment, the fault prediction unit may be configured to predict the possibility of a fault in the vehicle seat if the intensity of vibration generated during folding or unfolding of the vehicle seat exceeds a preset vibration value, based on vibration analysis using vibration information included in the sensing information transmitted from the inspection unit, or to predict the possibility of a fault in the vehicle seat through analysis of a variation in vibration generated during folding or unfolding of the vehicle seat.

In one embodiment, a vehicle seat gap measurement and fault prediction system according to another embodiment of the present invention may further include a seat cleaning unit installed in the vehicle production line, the seat cleaning unit being configured to remove foreign substances attached to the vehicle seat, which is being moved by the seat tray, by spraying compressed air.

In one embodiment, the seat cleaning unit may include an installation housing having a polygonal frame shape and installed in the vehicle production line so that the vehicle seat, which is being moved by the seat tray, could pass through the inner side thereof; a rear cleaning unit installed on an inward surface of a rear of the installation housing, facing a rear of the vehicle seat, and configured to clean the rear of the vehicle seat; and a front cleaning unit installed on an inward surface of a front inclined surface of the installation housing, the front inclined surface facing both a front of a seatback and an upper side of a seat cushion of the vehicle seat, and configured to clean the front of the seatback and the upper side of the seat cushion.

In one embodiment, the front cleaning unit may include an inclined rail formed to extend along an inward surface of a front inclined surface of the installation housing; a slider coupled to the inclined rail so as to be slidable along the rail; a plurality of rail arms sequentially connected to a front of the slider so as to be rotatably driven with respect to each other, the rail arms forming multiple connecting joints and being configured such that each joint could be rotatably driven to face both the seatback and the seat cushion of the vehicle seat in a parallel orientation; and at least one cleaning module installed on a lower surface of each of the plurality of rail arms and configured to clean a front of the seatback or an upper side of the seat cushion while facing the vehicle seat.

In one embodiment, the cleaning module may include a rail groove formed to extend along a lower surface of the rail arm; a module slider configured to slide along the rail groove and move to a compressed air injection position; a module body installed at a lower end of the module slider; a rotation guide groove formed to extend along an inner surface of the module body while defining an opening on a lower side of the module body, the rotation guide groove having threads formed along an inner circumferential surface; a rotation injection unit having a cylindrical shape and rotatably installed within the internal space of the rotation guide groove by thread engagement with the internal threads of the rotation guide groove, and configured to be inserted into or exposed from the rotation guide groove according to forward or reverse rotation; an actuator installed inside the rotation guide groove to support a rear of the rotation injection unit and configured to extend or contract to move the rotation injection unit forward or backward; and an injection nozzle installed along a front of the rotation injection unit and configured to inject compressed air for removing foreign substances.

In one embodiment, the rotation injection unit may include an injection body having a cylindrical shape and rotatably connected to a front of the actuator; a hollow groove formed inside the injection body; a rotation shaft disposed along the center of the internal space of the hollow groove so as to be rotatable; a shaft driving motor installed upright at an upper side of the hollow groove, with a drive shaft to which an upper end of the rotation shaft is coupled by shaft coupling, the shaft driving motor being configured to rotate the rotation shaft in a forward or reverse direction; a plurality of “+”-shaped rotors, each having four rounded ends and installed at regular intervals along the rotation shaft by shaft coupling, the “+”-shaped rotors rotating together as the rotation shaft rotates; horizontal moving frames inserted through the injection body in the horizontal direction on the same plane in a mutually orthogonal arrangement of four, each being in close contact with the “+”-shaped rotors in the hollow groove and configured to move simultaneously away from or toward the rotation shaft as the “+”-shaped rotors rotate; curved covers formed by bending flat plates and installed at the fronts of the respective horizontal moving frames, covering the injection body and having threads on their outer surfaces for engagement with internal threads of the rotation guide groove; cover support springs installed between the curved covers and the injection body and configured to pull the curved covers toward the injection body; first magnetic elements installed inside the curved covers to generate magnetism; second magnetic elements formed in a ring shape along the inner side of the rotation guide groove, facing the first magnetic elements, and also configured to generate magnetism; and a magnetic switch configured to switch the magnetic poles of the first and second magnetic elements to either N-pole or S-pole in order to cause the curved covers to either engage with or separate from the inner side of the rotation guide groove.

In one embodiment, the injection nozzle may include a nozzle mounting groove recessed at a front of the rotation injection unit; an elastic cover made of a stretchable material capable of extending and contracting, the elastic cover being installed to cover a front opening of the nozzle mounting groove, expanding into a hemispherical shape by hydraulic pressure when fluid is supplied into the nozzle mounting groove, and returning to a flat shape as the fluid is discharged from the nozzle mounting groove; and a plurality of nozzles radially installed along the elastic cover, each configured to inject compressed air, wherein the nozzles inject compressed air in a direction perpendicular to the elastic cover when the elastic cover is flat, and vary the injection direction of the compressed air as the elastic cover expands.

### BRIEF DESCRIPTION OF THE DRAWINGS

FIG. 1 is a diagram illustrating a schematic configuration of a vehicle seat gap measurement and fault prediction system according to one embodiment of the present invention.

FIGS. 2 and 3 are diagrams illustrating a gap measurement method using the vehicle seat gap measurement and fault prediction system according to the embodiment of the present invention shown in FIG. 1.

FIG. 4 is a diagram illustrating the rail frame shown in FIG. 1.

FIG. 5 is a diagram illustrating the inspection unit shown in FIG. 1.

FIGS. 6 and 7 are diagrams illustrating the bundle connector of FIG. 5.

FIG. 8 is a diagram illustrating a schematic configuration of a vehicle seat gap measurement and fault prediction system according to another embodiment of the present invention.

FIG. 9 is a diagram illustrating a schematic configuration of a vehicle seat gap measurement and fault prediction system according to yet another embodiment of the present invention.

FIGS. 10 and 11 are diagrams illustrating the cleaning module shown in FIG. 9.

FIGS. 12 and 13 are diagrams illustrating the rotation injection unit of FIG. 11.

FIG. 14 is diagrams illustrating the injection nozzle of FIG. 11.

### DETAILED DESCRIPTION

The following detailed description of the present invention refers to the accompanying drawings, which illustrate specific embodiments in which the invention may be implemented by way of example. These embodiments are described in sufficient detail to enable those skilled in the art to practice the invention. It should be understood that the various embodiments of the present invention may differ from one another, but need not be mutually exclusive. For example, specific shapes, structures, and features described herein in connection with one embodiment may be implemented in other embodiments without departing from the spirit and scope of the present invention. Furthermore, the positions or arrangements of individual components within each disclosed embodiment may be modified without departing from the spirit and scope of the present invention. Therefore, the following detailed description is not intended to be taken in a limiting sense, and the scope of the present invention is defined solely by the appended claims, along with the full range of equivalents to which such claims are entitled, as properly explained. Like reference numerals in the drawings refer to identical or similar functions across various aspects.

Hereinafter, preferred embodiments of the present invention will be described in greater detail with reference to the accompanying drawings.

According to one aspect of the present invention, there is provided a vehicle seat gap measurement and fault prediction system, which is configured to measure a gap between two seat parts assembled in close contact in a vehicle seat, and to predict the possibility of a fault in the vehicle seat based on sensing information generated during the gap measurement or through artificial intelligence analysis.

The technical problems to be solved by the present invention are not limited to those mentioned above, and other technical problems not specifically stated herein will be clearly understood by those skilled in the art from the following description.

According to one aspect of the present invention, it is possible to predict the possibility of a fault in a vehicle seat by measuring a gap between two seat parts assembled in close contact in the vehicle seat and by using sensing information generated during the gap measurement or through analysis using artificial intelligence.

The effects of the present invention are not limited to those mentioned above, and various other effects may be included within the scope apparent to those of ordinary skill in the art based on the following description.

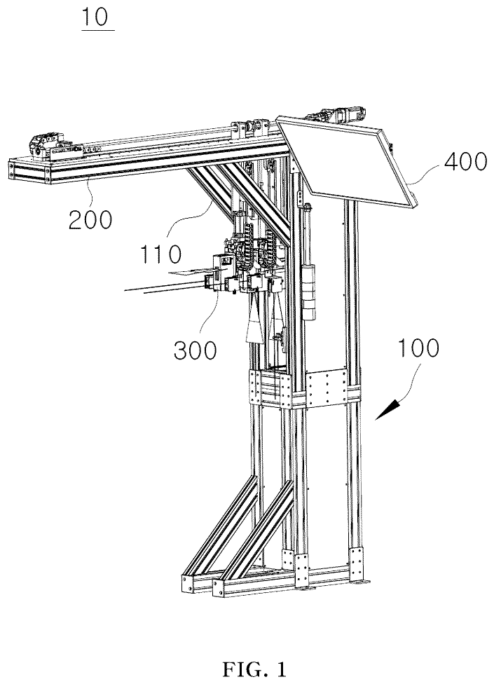

FIG. 1 is a diagram illustrating a schematic configuration of a vehicle seat gap measurement and fault prediction system according to one embodiment of the present invention.

Referring to FIG. 1, a vehicle seat gap measurement and fault prediction system 10 according to one embodiment of the present invention includes a main frame 100, a rail frame 200, an inspection unit 300, a normality determination unit 400, and a fault prediction unit 800.

The main frame 100 is installed at one side of a vehicle production line L for moving a seat tray on which a vehicle seat S (for example, a third-row seat of a vehicle) is mounted, the vehicle seat being configured such that a first seat S1 and a second seat S2 are assembled in close contact.

In one embodiment, the main frame 100 is composed of a high-strength profile, which could enhance the structural stability of the equipment, and a reinforcement unit 110 is installed between the main frame 100 and the rail frame 200 to reinforce and stabilize the structural protrusion of the rail frame 200 and reduce its vibration.

The rail frame 200 is installed in a horizontal direction at an upper portion of the main frame 100 while facing the vehicle production line L, and components such as the inspection unit 300 are installed thereon.

The inspection unit 300 is coupled to the rail frame 200 so as to be slidable along the rail frame, and is configured to retract along the rail frame 200 to approach the main frame 100 when the vehicle seat S is moving, and to advance along the rail frame 200 to face a measurement position of the vehicle seat S during gap measurement. The inspection unit senses a gap, i.e., a step difference, between the first seat S1 and the second seat S2.

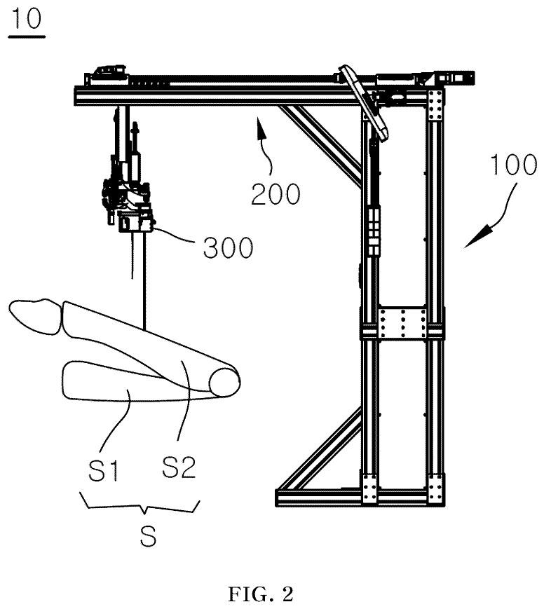

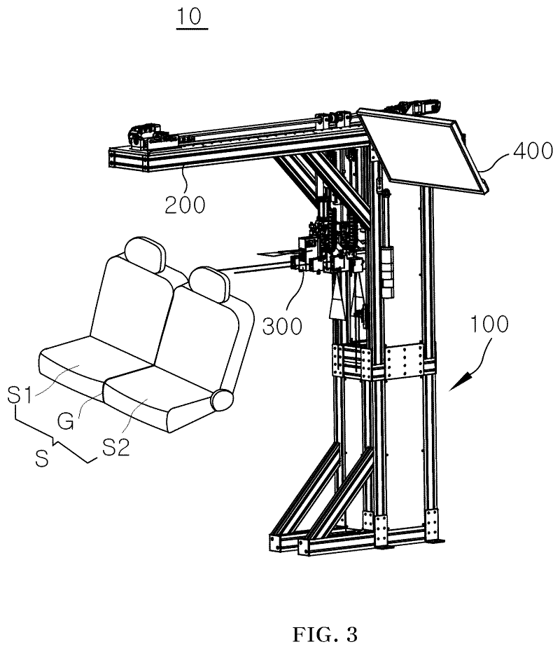

In one embodiment, as shown in FIG. 2, the inspection unit 300 senses a gap between the first seat S1 and the second seat S2 by moving forward and facing downward before tilting of the vehicle seat S. As shown in FIG. 3, after tilting of the vehicle seat S, the inspection unit 300 may be positioned close to the main frame 100 and face forward to sense the gap between the first seat S1 and the second seat S2.

In one embodiment, the inspection unit 300 may be configured to track a folding or unfolding process of each of the first seat S1 and the second seat S2 and to sense a gap between the first seat S1 and the second seat S2 in real time.

In one embodiment, the inspection unit 300 may be configured to sense a gap between the first seat S1 and the second seat S2 by analyzing a difference in speed or a difference in displacement during a folding or unfolding process of each of the first seat S1 and the second seat S2.

In one embodiment, the inspection unit 300 may be configured to analyze a folding or unfolding speed of the first seat S1 and the second seat S2 by analyzing the position of an individual seat, which is either the first seat S1 or the second seat S2.

The normality determination unit 400 determines whether the vehicle seat S is acceptable by using sensing information transmitted from the inspection unit 300 to verify whether the gap between the first seat S1 and the second seat S2 falls within an allowable error range.

The fault prediction unit 800 predicts the possibility of a fault in the vehicle seat S based on sensing information transmitted from the inspection unit 300 or through analysis using artificial intelligence.

In one embodiment, the inspection unit 300 may be configured to sense a gap between the first seat S1 and the second seat S2 at various angles during the folding or unfolding process, even when the overall folding or unfolding speed of either the first seat S1 or the second seat S2 is within a normal range.

In one embodiment, the fault prediction unit 800 may be configured to determine that there is a possibility of a defect in a drive system or gear part of the vehicle seat S when a partial gap difference or speed difference occurs during a folding or unfolding process of either the first seat S1 or the second seat S2.

In one embodiment, the fault prediction unit 800 may be configured to construct an artificial intelligence-based fault prediction model for the vehicle seat S, the model being trained to predict the possibility of a fault in the vehicle seat S using, as input information, abnormal speed data by operation position and abnormal gap data by operation position during folding or unfolding of the vehicle seat S, the data being transmitted from the inspection unit 300.

In one embodiment, the fault prediction unit 800 may be configured to predict the possibility of a fault in the vehicle seat S if the intensity of vibration generated during folding or unfolding of the vehicle seat S exceeds a preset vibration value, based on vibration analysis using vibration information included in the sensing information transmitted from the inspection unit 300, or to predict the possibility of a fault in the vehicle seat S through analysis of a variation in vibration generated during the folding or unfolding of the vehicle seat S.

The vehicle seat gap measurement and fault prediction system 10 according to one embodiment of the present invention, having the configuration described above, is capable of predicting the possibility of a fault in a vehicle seat by measuring a gap between two seat parts assembled in close contact in the vehicle seat and by utilizing sensing information generated during the gap measurement or through analysis using artificial intelligence.

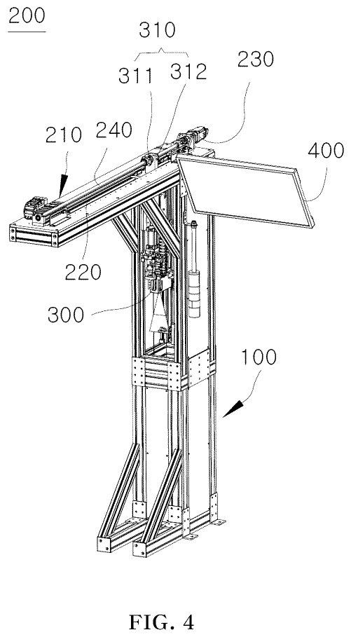

FIG. 4 is a diagram illustrating the rail frame shown in FIG. 1.

Referring to FIG. 4, the rail frame 200 includes a horizontal frame 210, a sliding hole 220, a servomotor 230, and a ball screw 240.

The horizontal frame 210 is installed at an upper portion of the main frame 100 so as to be perpendicular to the movement direction of the vehicle seat S while facing the vehicle production line L, and components such as the sliding hole 220, the servomotor 230, and the ball screw 240 are installed on the horizontal frame.

The sliding hole 220 is formed to extend in the longitudinal direction along a central portion of the horizontal frame 210 so that an upper portion of the inspection unit 300 could be seated and moved thereon, and components such as the servomotor 230 and the ball screw 240 are installed in association with the sliding hole 220.

The servomotor 230 is installed above the rear of the horizontal frame 210 and is configured to rotationally drive the ball screw 240 in a forward or reverse direction.

The ball screw 240 is coupled to a drive shaft of the servomotor 230 by shaft coupling and is arranged along an upper side of the sliding hole 220. An upper portion of the inspection unit 300 is connected to the ball screw 240 by bolt fastening, and the ball screw 240 is rotated in the forward or reverse direction by the servomotor 230 to move the inspection unit 300 forward or backward along the sliding hole 220.

The rail frame 200, having the configuration described above, is installed while facing the production line L and not only stably supports the inspection unit 300, but also enables precise sliding movement of the inspection unit 300 in correspondence with the sensing position.

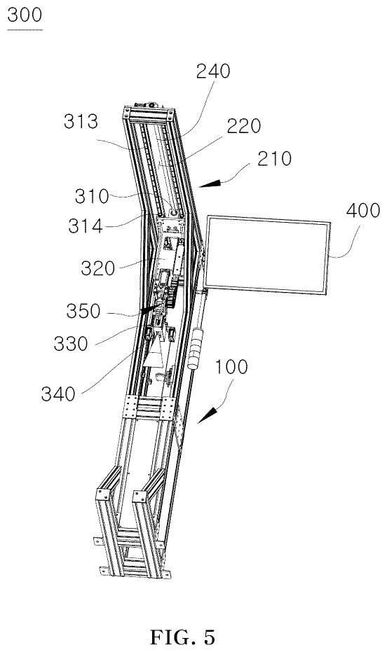

FIG. 5 is a diagram illustrating the inspection unit shown in FIG. 1.

Referring to FIG. 5, the inspection unit 300 includes a horizontal slider 310, a vertical body 320, a sensor casing 330, a gap measurement sensor 340, and a bundle connector 350.

The horizontal slider 310 is disposed in the sliding hole 220 and is coupled to the ball screw 240 by bolt-nut engagement. As the ball screw 240 is rotationally driven in a forward or reverse direction, the horizontal slider 310 moves along the sliding hole 220.

In one embodiment, as shown in FIG. 4, the horizontal slider 310 may include a connection nut 311 and a nut support 312.

The connection nut 311 is coupled to the ball screw 240 by bolt-nut engagement, and as the ball screw 240 is rotationally driven in a forward or reverse direction, the connection nut 311 moves along the ball screw 240 and thereby moves the nut support 312.

The nut support 312 is installed at an upper end of the vertical body 320 and is mounted to the connection nut 311. As the connection nut 311 moves, the nut support 312 moves along the sliding hole 220.

The horizontal slider 310, having the configuration described above, may further include a guide rail 313 and a guide 314.

The guide rail 313 is installed along one side and the other side of the downward-facing surface of the horizontal frame 210 with the sliding hole 220 positioned therebetween, so that the guide 314 could be coupled and moved along it.

The guide 314 is installed on one side and the other side of the upper portion of the vertical body 320, and is coupled to the guide rail 313 to slide along it, thereby guiding the horizontal movement of the vertical body 320.

The vertical body 320 is installed below the horizontal slider 310.

The sensor casing 330 is disposed below the vertical body 320.

The gap measurement sensor 340 is installed in the sensor casing 330 and is configured to sense a gap between the first seat S1 and the second seat S2.

In one embodiment, the gap measurement sensor 340 may be configured to move together while tracking the first seat S1 and the second seat S2 when either the first seat S1 or the second seat S2 is folded or unfolded, and simultaneously sense a gap between the first seat S1 and the second seat S2.

In one embodiment, as shown in FIG. 2, the gap measurement sensor 340 is installed on the lower side of the sensor casing 330 and may be configured to sense a gap between the first seat S1 and the second seat S2 in a folded state located below.

In one embodiment, as shown in FIG. 3, the gap measurement sensor 340 may be configured to sense a gap between the first seat S1 and the second seat S2 in an unfolded state located in front, when a mounting arm 354 is rotationally driven to rotate the lower side of the sensor casing 330 to face forward.

The bundle connector 350 interconnects the vertical body 320 and the sensor casing 330.

The inspection unit 300, having the configuration described above, is capable of not only precisely moving the gap measurement sensor 340, which performs sensing, in forward-rearward and up-down directions, but also precisely varying the sensing angle for accurate measurement.

That is, the inspection unit 300 having the configuration described above could eliminate the inconvenience of requiring multiple types of sensing devices depending on whether the vehicle seat is tilted. As shown in FIG. 2, before the tilting of the vehicle seat, the horizontal slider 310 may move forward along the rail frame 200, lower the sensor casing 330, and tilt the gap measurement sensor 340 downward to perform sensing. As shown in FIG. 3, after the tilting of the vehicle seat, the horizontal slider 310 may move backward along the rail frame 200 to approach the main frame 100, elevate the sensor casing 330, and tilt the gap measurement sensor 340 forward to perform sensing.

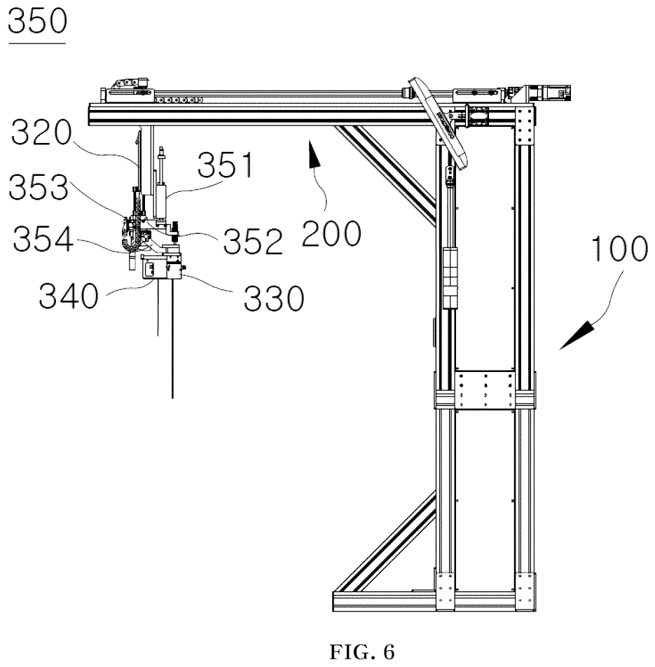

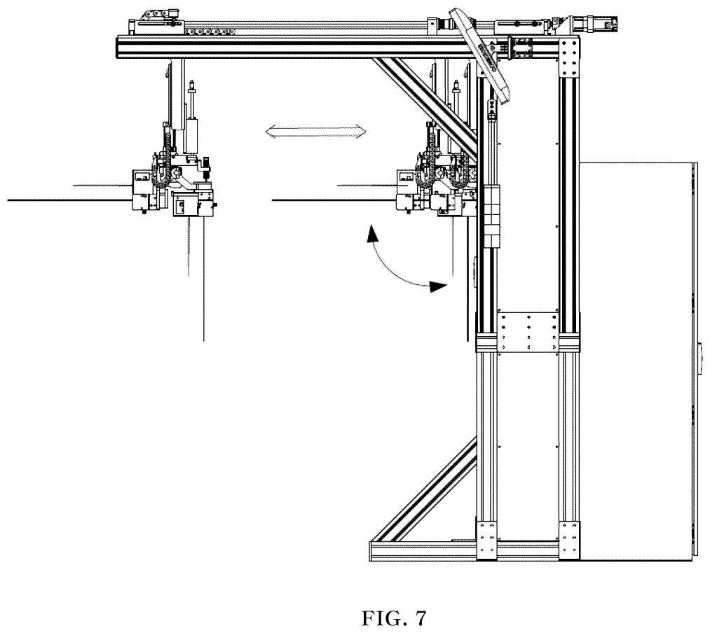

FIGS. 6 and 7 are diagrams illustrating the bundle connector shown in FIG. 5.

Referring to FIGS. 6 and 7, the bundle connector 350 includes a vertical cylinder 351, a connection plate 352, a rotation cylinder 353, and a mounting arm 354.

The vertical cylinder 351 is installed on the lower side of the vertical body 320 and is configured to extend or contract in a vertical direction, thereby vertically moving the connection plate 352 to move the gap measurement sensor 340 to a sensing position.

In one embodiment, the vertical cylinder 351 may be configured to contract and move the sensor casing 330 upward during folding or unfolding of the first seat S1 and the second seat S2, so as to prevent interference with the first seat S1 and the second seat S2.

The connection plate 352 moves up and down in the vertical direction by the operation of the vertical cylinder 351.

The rotation cylinder 353 is installed on one side of the connection plate 352 and is configured to rotationally drive the mounting arm 354.

The mounting arm 354 is coupled to a rotation shaft of the rotation cylinder 353 by shaft coupling and supports the sensor casing 330. It is rotationally driven by the rotation cylinder 353 to rotate the sensor casing 330.

The bundle connector 350, having the configuration described above, as shown in FIG. 7, enables precise sensing regardless of the sensing position on the vehicle seat by allowing the gap measurement sensor 340 to be adjusted not only in the vertical direction but also tilted according to the sensing position of the gap measurement sensor 340.

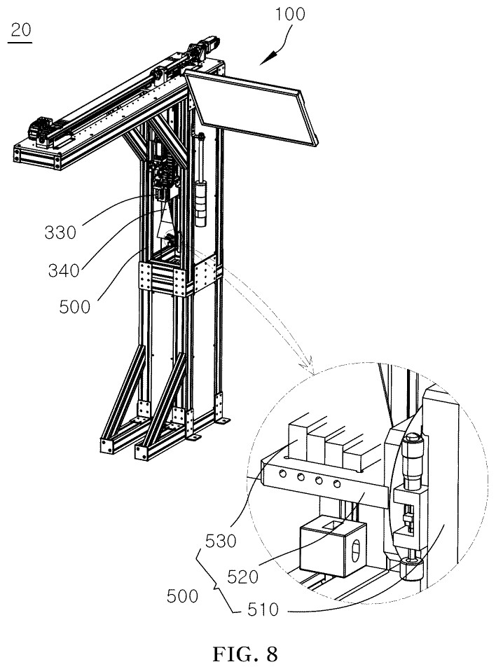

FIG. 8 is a diagram illustrating a schematic configuration of a vehicle seat gap measurement and fault prediction system according to another embodiment of the present invention.

Referring to FIG. 8, a vehicle seat gap measurement and fault prediction system 20 according to another embodiment of the present invention includes a main frame 100, a rail frame 200, an inspection unit 300, a normality determination unit 400, and a calibration unit 500.

Here, the main frame 100, rail frame 200, inspection unit 300, and normality determination unit 400 are identical to the components shown in FIG. 1, and therefore, descriptions thereof will be omitted to avoid redundancy.

The calibration unit 500 is installed on the main frame 100 to perform sensing calibration of the inspection unit 300.

In one embodiment, the calibration unit 500 may include a connector 510, a horizontal plate 520, and a calibration block 530.

The connector 510 is installed on the main frame 100 while facing the inspection unit 300 so that the horizontal plate 520 could be mounted thereon.

The horizontal plate 520 is installed at a front of the connector 510 to allow the calibration block 530 to be mounted thereon.

The calibration block 530 is installed on an upper surface of the horizontal plate 520 and has a series of step differences with uniform height intervals repeatedly formed along its top surface.

In one embodiment, the inspection unit 300 may perform calibration by detecting the step lines of the calibration block 530, and after the calibration is completed, it may perform sensing.

The vehicle seat gap measurement and fault prediction system 20 according to another embodiment of the present invention, having the configuration described above, could perform calibration internally without the need for separate calibration equipment, thereby enabling consistently accurate sensing without requiring additional devices.

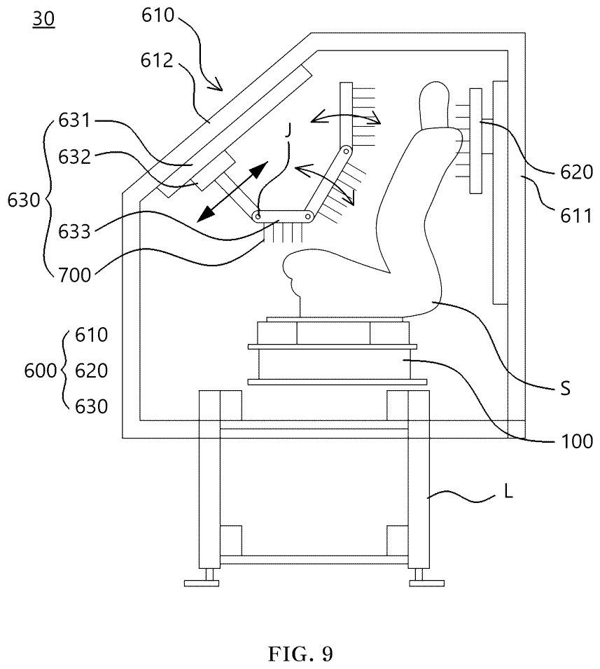

FIG. 9 is a diagram illustrating a schematic configuration of a vehicle seat gap measurement and fault prediction system according to yet another embodiment of the present invention.

Referring to FIG. 9, a vehicle seat gap measurement and fault prediction system 30 according to this embodiment includes a seat tray 100, a main frame 200, a forward driving unit 300, a first storive connector 400, and a seat cleaning unit 600.

Here, the seat tray 100, main frame 200, forward driving unit 300, and first storive connector 400 are identical to the components shown in FIG. 1, and therefore, their descriptions will be omitted to avoid redundancy.

The seat cleaning unit 600 is installed at one or more locations along the vehicle production line L and removes foreign substances such as dust attached to the vehicle seat S, which is being moved by the seat tray 100, by spraying compressed air.

In one embodiment, the seat cleaning unit 600 may include an installation housing 610, a rear cleaning unit 620, and a front cleaning unit 630.

The installation housing 610 has a polygonal frame shape and is installed on the vehicle production line L so that the vehicle seat S, which is being moved by the seat tray 100, could pass through its interior. Components such as the rear cleaning unit 620 and the front cleaning unit 630 are installed within the installation housing.

The rear cleaning unit 620 is installed on an inward-facing surface of a vertical surface 611 formed at the rear of the installation housing 610, facing the rear of the vehicle seat S, and cleans foreign substances such as dust by spraying compressed air in the direction of the rear of the vehicle seat S.

The front cleaning unit 630 is installed on an inward-facing surface of a front inclined surface 612 of the installation housing 610, which faces both the front of the seatback and the upper side of the seat cushion of the vehicle seat S. It sprays compressed air toward the front of the seatback and the upper side of the seat cushion to remove foreign substances such as dust.

In one embodiment, the front cleaning unit 630 may include an inclined rail 631, a slider 632, a rail arm 633, and a cleaning module 700.

Here, the rear cleaning unit 620 has the same configuration as the front cleaning unit 630 described below, and components such as the inclined rail 631, slider 632, rail arm 633, and cleaning module 700 of the front cleaning unit 630 could be equally applied to the rear cleaning unit 620. Therefore, to avoid redundancy, detailed descriptions thereof will be omitted.

The inclined rail 631 is formed to extend along the inward-facing surface of the front inclined surface 612 of the installation housing 610 so that the slider 632 could be coupled and slidably moved along it.

The slider 632 is coupled to the inclined rail 631 so as to be slidable, and moves the rail arm 633 in response to a cleaning position.

The rail arm 633 includes a plurality of segments connected sequentially from the front of the slider 632 so as to be rotatably driven relative to each other, forming multiple connecting joints (J). Each connecting joint is rotatably driven so that the rail arm 633 could face and align in parallel with both the seatback and the seat cushion of the vehicle seat S.

The cleaning module 700 is installed on at least one location on the lower surface of each of the plurality of rail arms 633 that face the vehicle seat S, and performs cleaning by spraying compressed air toward the front of the seatback or the upper side of the seat cushion to remove foreign substances.

The vehicle seat gap measurement and fault prediction system 30 according to yet another embodiment of the present invention, having the configuration described above, is capable of improving the manufacturing quality of the vehicle seat S by removing foreign substances such as dust attached to the vehicle seat S during its movement, without requiring the production process to be stopped.

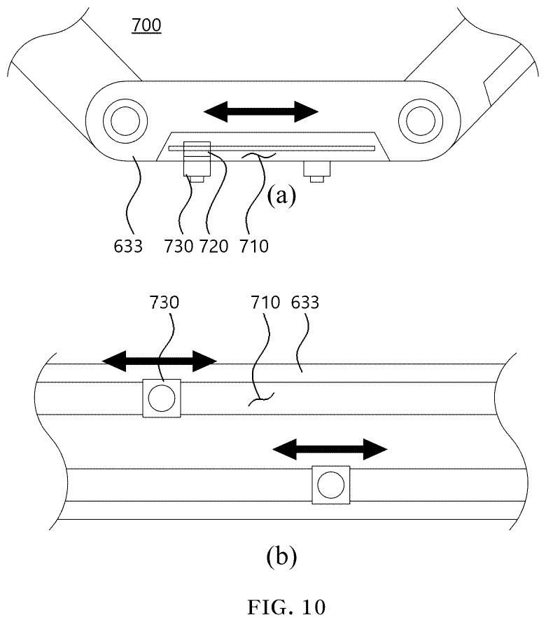

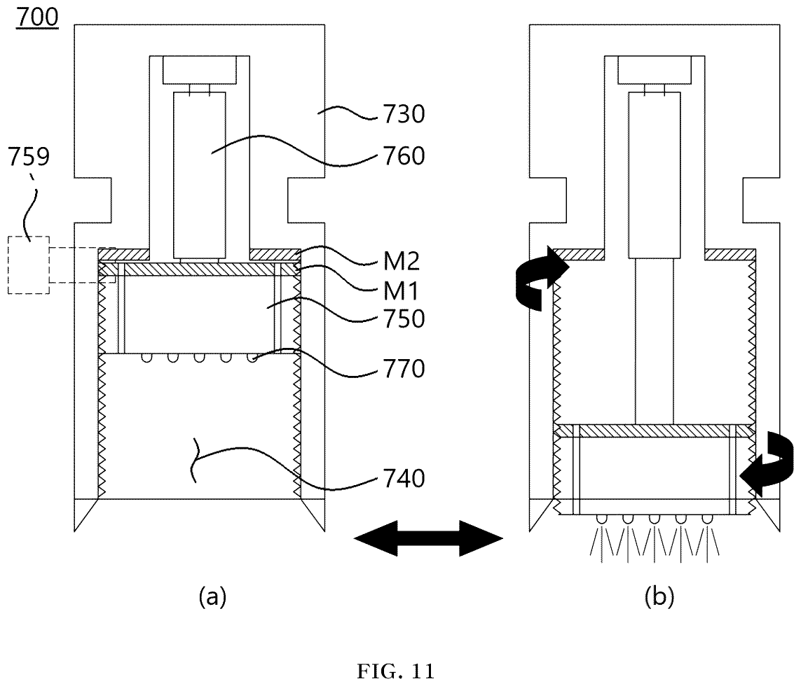

FIGS. 10 and 11 are diagrams illustrating the cleaning module shown in FIG. 9.

Referring to FIGS. 10 and 11, the cleaning module 700 includes a rail groove 710, a module slider 720, a module body 730, a rotation guide groove 740, a rotation injection unit 750, an actuator 760, and an injection nozzle 770.

The rail groove 710 is formed to extend along the lower surface of the rail arm 633 so that the module slider 720 could be coupled thereto and slide along it.

The module slider 720 slides along the rail groove 710 to move to a compressed air injection position and thereby moves the module body 730.

The module body 730 is installed at the lower end of the module slider 720 and includes components such as the rotation guide groove 740, the rotation injection unit 750, the actuator 760, and the injection nozzle 770.

The rotation guide groove 740 is formed to extend along the inner side of the module body 730 while defining an opening on the lower side of the module body, so that the rotation injection unit 750 could be inserted, engaged, or exposed. Threads are formed along the inner circumferential surface of the groove.

The rotation injection unit 750 has a cylindrical shape and is rotatably installed inside the rotation guide groove 740 by being threadably engaged with the internal threads of the rotation guide groove. As it rotates in a forward or reverse direction, it is either inserted into or exposed from the inside of the rotation guide groove 740.

In one embodiment, the rotation injection unit 750 may rotate and move along the rotation guide groove 740 as the actuator 760 extends or contracts, when a curved cover 757 (described below) is separated from the injection body 751 and comes into close contact with the inner circumferential surface of the rotation guide groove 740. Conversely, when the curved cover 757 is pressed against the injection body 751 and separated from the inner surface of the rotation guide groove 740, the actuator 760 may cause the rotation injection unit 750 to move linearly along the rotation guide groove 740 without rotation.

In one embodiment, as shown in (a) of FIG. 11, when the rotation injection unit 750 is inserted into the interior of the rail groove 710, it may reduce the injection angle of compressed air discharged from the cleaning module 700, thereby decreasing the cleaning area affected by the compressed air. Conversely, as shown in (b) of FIG. 11, when the rotation injection unit 750 moves forward to the front of the rail groove 710, it may increase the injection angle of the compressed air, thereby expanding the cleaning area covered by the compressed air.

The actuator 760 is installed inside the rotation guide groove 740, supports the rear of the rotation injection unit 750, and extends or contracts to move the rotation injection unit 750 forward or backward.

The injection nozzle 770 is installed along the front of the rotation injection unit 750 and removes foreign substances by spraying compressed air supplied from an external compressed air supply device (not shown in the drawings for convenience of explanation).

The cleaning module 700, having the configuration described above, could improve the efficiency of foreign substance removal by either inducing rotation of the compressed air discharged from the injection nozzle 770 or varying the injection angle of the compressed air, through rotational driving of the module body 730.

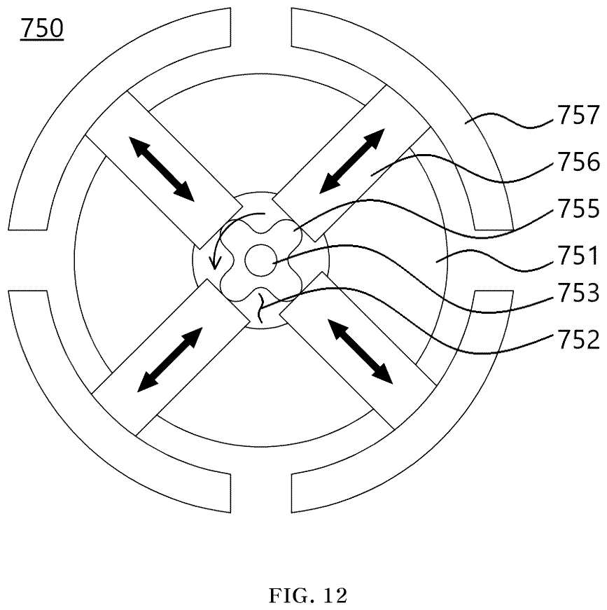

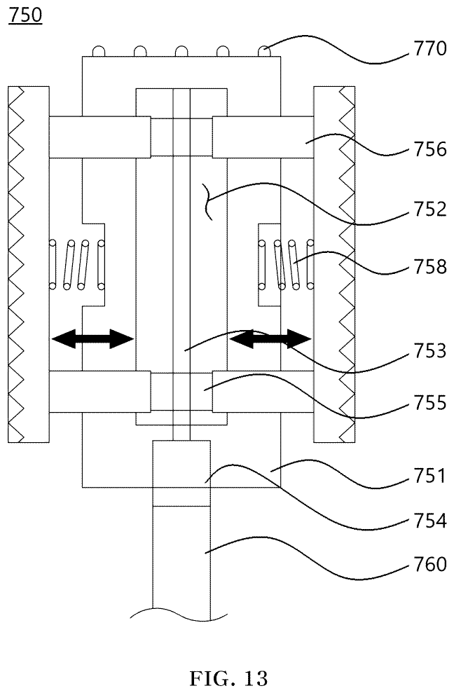

FIGS. 12 and 13 are diagrams illustrating the rotation injection unit shown in FIG. 11.

Referring to FIGS. 12 and 13, the rotation injection unit 750 includes an injection body 751, a hollow groove 752, a rotation shaft 753, a shaft driving motor 754, a “+”-shaped rotor 755, a horizontal moving frame 756, a curved cover 757, and a cover support spring 758.

The injection body 751 is formed in a cylindrical shape and is rotatably connected to the front of the actuator 760. A front of the injection body 751, which is exposed from the rotation guide groove 740, is equipped with the injection nozzle 770. The injection body 751 includes components such as the hollow groove 752, the rotation shaft 753, the shaft driving motor 754, the “+”-shaped rotor 755, the horizontal moving frame 756, the curved cover 757, a first magnetic element (M1), a second magnetic element (M2), the cover support spring 758, and the magnetic switch 759.

The hollow groove 752 is formed as a hollow space along the interior of the injection body 751, providing sufficient room for the placement and rotation of the rotation shaft 753 and the “+”-shaped rotor 755.

The rotation shaft 753 is arranged to be rotatable along the center of the internal space of the hollow groove 752 and is rotationally driven by the shaft driving motor 754 to rotate the “+”-shaped rotor 755 together with it.

The shaft driving motor 754 is installed upright on the upper side of the hollow groove 752, and the upper end of the rotation shaft 753 is coupled to the drive shaft of the motor by shaft coupling. The motor rotationally drives the rotation shaft in a forward or reverse direction.

The “+”-shaped rotor 755 has a “+” shape with four rounded ends and is installed at regular intervals along the rotation shaft 753 by shaft coupling. As the rotation shaft rotates, the plurality of “+”-shaped rotors rotate together and support respective ends of the horizontal moving frames 756.

The horizontal moving frames 756 are arranged in a cross configuration with four frames positioned at right angles to one another on the same plane. Each frame horizontally penetrates and is inserted through the injection body 751 and is closely fitted to a respective “+”-shaped rotor 755 within the hollow groove 752. As the “+”-shaped rotors 755 rotate, the horizontal moving frames 756 simultaneously move horizontally either away from or toward the rotation shaft 753.

That is, the horizontal moving frames 756 may move horizontally away from the rotation shaft 753 when they are in close contact with the end of each arm of the “+”-shaped rotor 755, and may move toward the rotation shaft 753 when they are in close contact with the corners between the arms of the “+”-shaped rotor 755.

The curved cover 757 is formed by bending a flat plate into a curved shape and is supported by the cover support spring 758. It is installed at the front of each of the plurality of horizontal moving frames 756 to cover the injection body 751. Threads are formed along the outer surface of the curved cover 757 so that it could be engaged with the internal threads on the inner surface of the rotation guide groove 740.

That is, the curved cover 757, as the horizontal moving frame 756 comes into contact with the end of each arm of the “+”-shaped rotor 755, moves away from the rotation shaft 753 and engages with the internal threads on the inner surface of the rotation guide groove 740. Conversely, as the horizontal moving frame 756 comes into contact with the corners between the arms of the “+”-shaped rotor 755, the curved cover 757 moves in a direction approaching the rotation shaft 753 and becomes disengaged from the internal threads of the rotation guide groove 740 along its outer surface.

The cover support spring 758 is installed between the curved cover 757 and the injection body 751 and pulls the curved cover 757 toward the injection body 751. The rotation injection unit 750, having the configuration described above, may further include a first magnetic element (M1), a second magnetic element (M2), and a magnetic switch 759.

The first magnetic element (M1) is installed on the inner side of the curved cover 757 and generates a magnetic polarity of either “N” or “S” under the control of the magnetic switch 759.

The second magnetic element (M2) is formed in a circular ring shape along the inner side of the rotation guide groove 740, facing the first magnetic element (M1), and likewise generates a magnetic polarity of either “N” or “S” under the control of the magnetic switch 759.

The magnetic switch 759 controls the magnetic polarity of the first magnetic element (M1) and the second magnetic element (M2) by switching them to either the “N” or “S” pole, thereby guiding the curved cover 757 to either engage with or disengage from the inner surface of the rotation guide groove 740.

With the configuration described above, the rotation injection unit 750 enables effective and precise engagement and disengagement with the inner surface of the rotation guide groove 740.

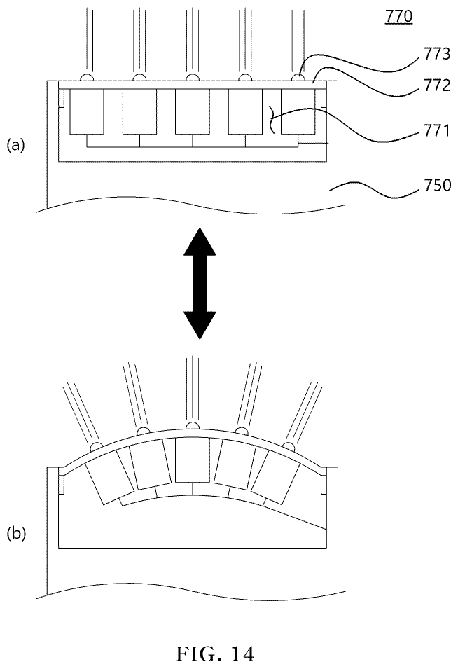

FIG. 14 is a diagram illustrating the injection nozzle shown in FIG. 11.

Referring to FIG. 14, the injection nozzle 770 includes a nozzle mounting groove 771, an elastic cover 772, and a plurality of nozzles 773.

The nozzle mounting groove 771 is recessed at the front of the rotation injection unit 750.

The elastic cover 772 is made of a stretchable and contractible elastic material and is installed to cover the front opening of the nozzle mounting groove 771. When a fluid such as water or oil is supplied into the nozzle mounting groove 771, the cover expands into a hemispherical shape due to hydraulic pressure, and returns to a flat shape as the fluid is discharged from the nozzle mounting groove 771.

The plurality of nozzles 773 are radially arranged along the elastic cover 772 and are configured to spray compressed air. When the elastic cover 772 is in a flat state, the nozzles spray compressed air in a direction perpendicular to the surface of the cover. As the elastic cover 772 expands, the spray direction of the compressed air changes accordingly.

With the configuration described above, the injection nozzle 770 could vary and precisely control the spray area of the compressed air, depending on whether the elastic cover 772 is contracted (as shown in (a) of FIG. 14) or expanded (as shown in (b) of FIG. 14). This enhances the efficiency of foreign substance removal.

The above-described embodiments are provided for illustrative purposes, and it will be understood by those skilled in the art to which the present invention pertains that various modifications could be made without departing from the technical spirit or essential characteristics of the described embodiments. Therefore, the disclosed embodiments should be regarded as illustrative rather than limiting in every respect. For example, each component described as a single unit may be implemented in a distributed manner, and likewise, components described as being distributed may be implemented in a combined form.

What is claimed is:

1. A vehicle seat gap measurement and fault prediction system, comprising:
a main frame installed at one side of a vehicle production line for transporting a seat tray on which a vehicle seat, where a first seat and a second seat are closely mounted, is installed;
a rail frame horizontally installed on top of the main frame, oriented toward the vehicle production line;
an inspection unit slidably engaged and connected to the rail frame, configured to retract along the rail frame toward the main frame as the vehicle seat moves, and to advance along the rail frame to face a measurement position of the vehicle seat during gap measurement, the inspection unit being configured to sense a gap between the first seat and the second seat while tracking respective folding or unfolding operations of the first seat and the second seat;
a normality determination unit configured to determine whether the vehicle seat is acceptable using sensing information received from the inspection unit; and
a fault prediction unit configured to predict a potential fault of the vehicle seat based on the sensing information received from the inspection unit or through artificial intelligence analysis.

2. The system of claim 1,
wherein the inspection unit is configured to sense the gap between the first seat and the second seat by analyzing a speed difference or a displacement difference occurring during respective folding or unfolding processes of the first seat and the second seat.

3. The system of claim 2,
wherein the rail frame comprises:
a horizontal frame installed on top of the main frame and oriented toward the vehicle production line so as to be perpendicular to a movement direction of the vehicle seat;
a sliding hole formed to extend longitudinally along a middle portion of the horizontal frame, in which an upper portion of the inspection unit is attached and allowed to move;
a servo motor installed at an upper rear of the horizontal frame; and
a ball screw installed by shaft coupling to a drive shaft of the servo motor, arranged along an upper portion of the sliding hole, the upper portion of the inspection unit being bolted and connected to the ball screw, the ball screw being driven in forward or reverse rotational direction by the servo motor to move the inspection unit forward or backward along the sliding hole,
wherein the inspection unit comprises:
a horizontal slider disposed in the sliding hole and connected to the ball screw via a bolt-nut coupling, the horizontal slider moving along the sliding hole as the ball screw is rotated in a forward or reverse direction;
a vertical body installed below the horizontal slider;
a sensor casing arranged below the vertical body;
a gap measurement sensor installed in the sensor casing and configured to sense a gap between the first seat and the second seat; and
a bundle coupling unit configured to interconnect the vertical body and the sensor casing.

4. The system of claim 3,
wherein the gap measurement sensor is configured to move in conjunction with the first seat and the second seat while tracking the first seat and the second seat during folding or unfolding, and simultaneously sense the gap between the first seat and the second seat.

5. The system of claim 4,
wherein the inspection unit is configured to sense the gap between the first seat and the second seat at various angles during the folding or the unfolding process, even when an overall folding or unfolding speed of the first seat or the second seat is within a normal range.

6. The system of claim 5,
wherein the fault prediction unit is configured to determine that there is a possibility of fault in a drive system or gear portion of the vehicle seat when a partial gap difference or speed difference occurs during the folding or the unfolding process of the first seat or the second seat.

7. The system of claim 6,
wherein the fault prediction unit is configured to construct an artificial intelligence-based fault prediction model for the vehicle seat, trained to predict the possibility of fault of the vehicle seat using abnormal speed data corresponding to operational positions during folding or unfolding transmitted from the inspection unit and abnormal gap data corresponding to the operational positions during folding or unfolding transmitted from the inspection unit as input data.

8. The system of claim 7,
wherein the fault prediction unit is configured to predict the possibility of fault of the vehicle seat by performing vibration analysis using vibration information included in the sensing data transmitted from the inspection unit, when an intensity of vibration generated during folding or unfolding of the vehicle seat exceeds a predetermined vibration threshold, or predict the possibility of fault of the vehicle seat based on analysis of variation in vibration during folding or unfolding.

9. The system of claim 1, further comprising:
a seat cleaning unit installed in the vehicle production line, configured to remove foreign substances attached to the vehicle seat moving along with the seat tray by spraying compressed air,
wherein the seat cleaning unit comprises:
an installation housing formed in a polygonal frame shape and installed in the vehicle production line;
a rear cleaning unit installed on an inner surface at a rear of the installation housing, facing a rear of the vehicle seat, and configured to clean the rear of the vehicle seat; and
a front cleaning unit installed on an inner inclined surface at a front of the installation housing, facing both a front surface of a seat back and an upper surface of a seat cushion, and configured to clean the front surface of the seat back and the upper surface of the seat cushion.

10. The system of claim 9,
wherein the front cleaning unit comprises:
an inclined rail formed to extend along an inner surface of an inclined front surface of the installation housing;
a slider slidably coupled to the inclined rail;
a plurality of rail arms sequentially connected from a front end of the slider, each rail arm being rotatable relative to an adjacent rail arm, the plurality of rail arms forming a plurality of joints, each joint being driven to rotate such that the rail arms are oriented in parallel with both the seat back and the seat cushion of the vehicle seat; and
at least one cleaning module disposed on each lower surface of the plurality of rail arms, facing the vehicle seat, and configured to clean a front surface of the seat back or an upper surface of the seat cushion,
wherein the cleaning module comprises:
a rail groove formed along the lower surface of the rail arm;
a module slider configured to slide along the rail groove to move to a compressed air spraying position;
a module body installed at a lower portion of the module slider;
a rotational guide groove that is formed along an inner side surface of the module body, the rotational guide groove including an opening positioned at a lower portion of the module body and having internal threads formed along an inner circumferential surface of the rotational guide groove;
a rotation injection unit of cylindrical shape, rotatably installed in an internal space of the rotational guide groove, and coupled to internal threads of the rotational guide groove so as to be inserted into or exposed from the rotational guide groove by rotating in a forward or reverse direction;
an actuator installed inside the rotational guide groove and configured to support a rear of the rotation injection unit, the actuator being driven to extend or contract to move the rotation injection unit forward or backward; and
an injection nozzle installed along a front of the rotation injection unit to spray compressed air for removing foreign substances,
wherein the rotation injection unit comprises:
a nozzle body of cylindrical shape rotatably connected to a front of the actuator;
a hollow groove formed inside the nozzle body;
a rotation shaft disposed at a center of the hollow groove so as to be rotatable;
a shaft driving motor vertically installed above the hollow groove and having a driving shaft coupled to a top end of the rotation shaft to rotate the rotation shaft in a forward or reverse direction;
a plurality of “+”-shaped rotors, each having four rounded tips, installed at intervals along the rotation shaft by shaft coupling to rotate together with the rotation shaft;
a plurality of horizontal movement frames each inserted perpendicularly into the nozzle body in four directions on a same plane, pressed and seated against the “+”-shaped rotors inside the hollow groove, the frames being moved horizontally either away from or toward the rotation shaft by a rotation of the “+”-shaped rotors;
curved covers, formed by bending flat plates, installed at fronts of the horizontal movement frames to cover the nozzle body, and having external threads for engagement with the internal threads of the rotational guide groove;
cover support springs installed between the curved covers and the nozzle body to pull the curved covers toward the nozzle body;
a first magnetic element installed inside the curved cover to generate magnetism;
a second magnetic element formed in a circular ring shape along an inner surface of the rotational guide groove, facing the first magnetic element, and configured to generate magnetism; and
a magnetic switch configured to switch a polarity of the first and second magnetic elements between “N” and “S” poles, so as to engage or disengage the curved cover with or from an inside of the rotational guide groove.
